(19) United States
(12) Patent Application Publication
(10) Pub. No.: US 2008/0227592 A1
(43) Pub. Date: Sep. 18, 2008

(54) Method for Starting an Internal Combustion Engine in a Parallel Hybrid Drive Train

(75) Inventors: Oliver Steffen, Coburg (DE); Axel Heitmann, Ingolstadt (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/663,122

(22) PCT Filed: Sep. 16, 2005
(86) PCT No.: PCT/EP05/09964

§ 371 Date: Oct. 24, 2007

(30) Foreign Application Priority Data
Sep. 18, 2004 (DE) 10 2004 045 424.8

(51) Int. Cl. B60K 6/20; F02N 11/00

(52) U.S. Cl. 477/19

(57) ABSTRACT

A method for starting an internal combustion engine in a parallel hybrid drive train of a motor vehicle. The drive train comprises an automatic transmission (1) providing a drive shaft (2) connected to an internal combustion engine, one output shaft (3) connected to one driving axle of the motor vehicle, a mechanical transmission (4) encompassing a first and second planetary gearset (5, 6), several clutches and brakes, and an electric machine (14) used as a starter/generator and/or for continuously adjusting the transmission or electrically driving the motor vehicle. The electric machine (14) can be connected to a first and/or a second shaft of the first planetary gearset by two clutches so that the internal combustion engine can be started by actuating one of the two clutches when the vehicle is driven exclusively in the electric mode and the other clutch is engaged. The internal combustion engine is started by engaging the clutch (K4) which can be connected directly to the drive shaft (2) by engaging the same.

The invention concerns a process for starting an internal combustion engine in a parallel hybrid drive train according to the preamble of Patent Claim 1.

From the generic patent DE 101 40 424 A1, a process is known for starting an internal combustion engine in a motor vehicle with a parallel hybrid drive train. In addition to the internal combustion engine, this drive train comprises an automatic transmission, which features an input shaft that can be connected to the internal combustion engine, and an output shaft that can be coupled to at least one driving axle of the motor vehicle, as well as a manual transmission with a first and a second planetary gear set, a plurality of clutches, a plurality of brakes, and an electric machine.

The electric machine is actuatable as a starter/generator and/or for the continuous adjustment of the transmission and/or the electrical drive operation of the motor vehicle. The electric machine can also be connected by means of two of the clutches with a first shaft and/or a second shaft of the first planetary gear set in such a way that when there is purely electrical drive operation and an engaged clutch, the internal combustion engine can be started through actuation of the other two clutches. By engaging the other clutch, the starter torque is conducted via the shaft with the sun gear of the first planetary gear set into the latter and onto the drive shaft, so that the internal combustion engine can start.

At an interval of time after starting, the electric machine can be connected to the internal combustion engine via one of the two clutches, so that if required by the driver, torque can be boosted by the electric machine.

With this known process, the vehicle can be driven from a stationary position without a hydraulic converter, whereby a sun gear of the first planetary gear set can be connected with a starting brake via a shaft. From the two clutches arranged coaxially inside the electric machine, one clutch works with the shaft having the sun gear as described above, so that after the start brake is released and this one clutch is engaged, the torque for starting the internal combustion machine is conducted via the shaft having the sun gear of the first planetary gear set.

With this known process, under some circumstances, there can be slight, but undesirable interruptions in driving power in the drive train.

From DE 199 17 665 A1, a hybrid drive concept with two electric machines is disclosed, as is the use of a first electric machine to start the internal combustion engine for the purpose of reducing the driving power interruption phase in a purely electrical drive operation, and then to couple it into the drive train when the difference in rotational speeds between the internal combustion engine and the input transmission shaft is very small. However, this solution to the problem of driving power interruption requires two electric machines.

The present invention is therefore based on the goal of improving a generic process for starting an internal combustion engine so that driving power interruption is obviously reduced or completely avoided.

The problem of interruptions in driving power is resolved according to the features of the main claim by means of a process for starting an internal combustion engine in a parallel hybrid drive train of a motor vehicle, whereby the drive train comprises, in addition to the internal combustion engine, an automatic transmission that has an input shaft that can be connected to the internal combustion engine, and an output shaft that can be connected to at least one driving axle of the motor vehicle, as well as a mechanical transmission with a first and a second planetary gear set, a plurality of clutches, a plurality of brakes and an electric machine that can be used as a starter/generator and/or for continuous adjustment of the transmission and/or for electrical drive operation of the motor vehicle, whereby the electric machine can be connected in such a way, by means of two of the clutches, to a first shaft and/or a second shaft of the first planetary gear set, that when there is a purely electrical drive operation and an engaged clutch, the internal combustion engine can be started by actuating the other of the two clutches, whereby starting is achieved by engaging the clutch to directly connect to the input shaft.

By means of the inventive process, the internal combustion engine is advantageously started by a direct torque flow from the engaged clutch via the input shaft, without interconnection of the first planetary gear set and without having to engage an additional clutch in order to start. In the current state of the art, such operations normally lead to slight driving power interruptions and to slight but perceptible shifting jolts, which, with the inventive process, are completely avoided or reduced in length.

The process can be advantageously developed so that the electric machine is connected with the ring gear of the first planetary gear set via the clutch that is directly connected with the input shaft at the starting of the internal combustion engine.

Just as advantageously, the process can be alternatively or further developed such that the electric machine can be connected to the sun gear of the first planetary gear set via the other of the two clutches.

It is particularly preferable that the two clutches are configured as multiple disc clutches and can be independently shifted or regulated.

Depending on the respective application, however, it may also be advantageous for the independently shiftable clutches to be form locking clutches.

It is preferred that while driving with the internal combustion engine turned off, a planet carrier of the first planetary gear set be locked by engagement, through a clutch, with a brake on the transmission housing. In that way, the necessary torque support for the existing purely electrical drive operation is realized in a particularly simple way, and there is a positive effect on the actuating sequence of the shifting elements.

This favorable actuation sequence then continues when this torque support is sustained in an additional, preferred process sequence after the internal combustion engine is started, until when switching into a third gear, the engaged brake is preferably released.

In other cases of gear shifting, it can be advantageous to actuate an intermediate shifting stage without changing the gear transmission ratio, in order to avoid too many of shifting elements being actuated at the same time, thereby potentially negatively influencing the shifting comfort. This is accomplished by engaging a clutch to interpose this intermediate shifting stage, which couples the ring gear of the first planetary gear set to the planet carrier of the second planetary gear set.

Favorable torque effects are produced when the gear transmission ratios in the connected gears of the drive train are i=2.74, i=1.54, i=1.0 and/or i=0.867.

Additional advantages and features of the invention will now be described by way of example with reference to an embodiment shown in the attached drawings. The Figures show:

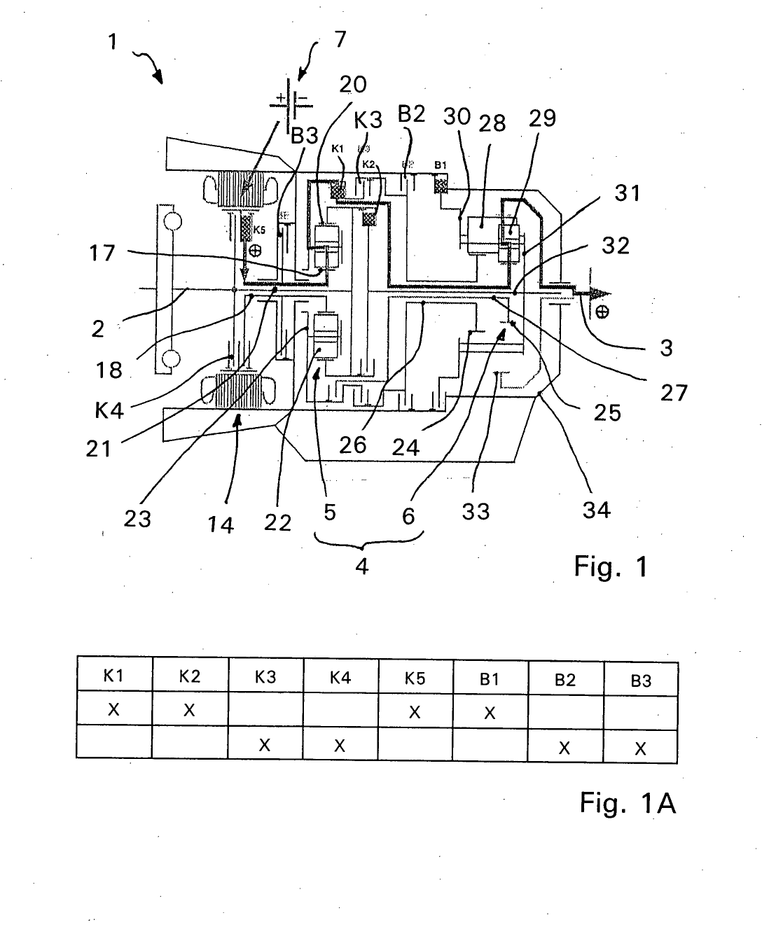

FIG. 1 is a schematic sectional view of a transmission in a start position;

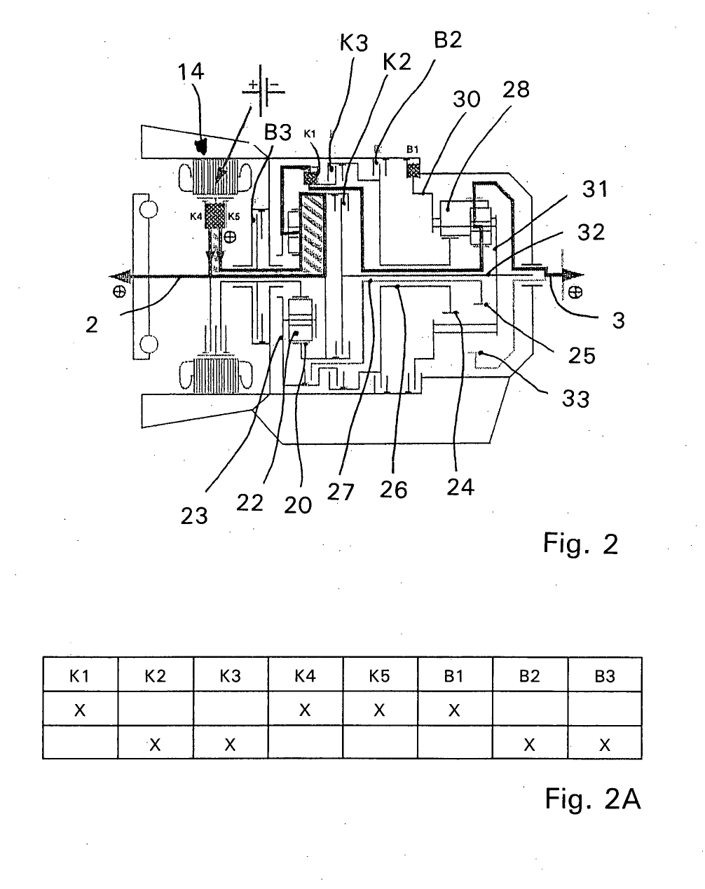

FIG. 2 is the transmission according to FIG. 1 during a direct start of an internal combustion engine;

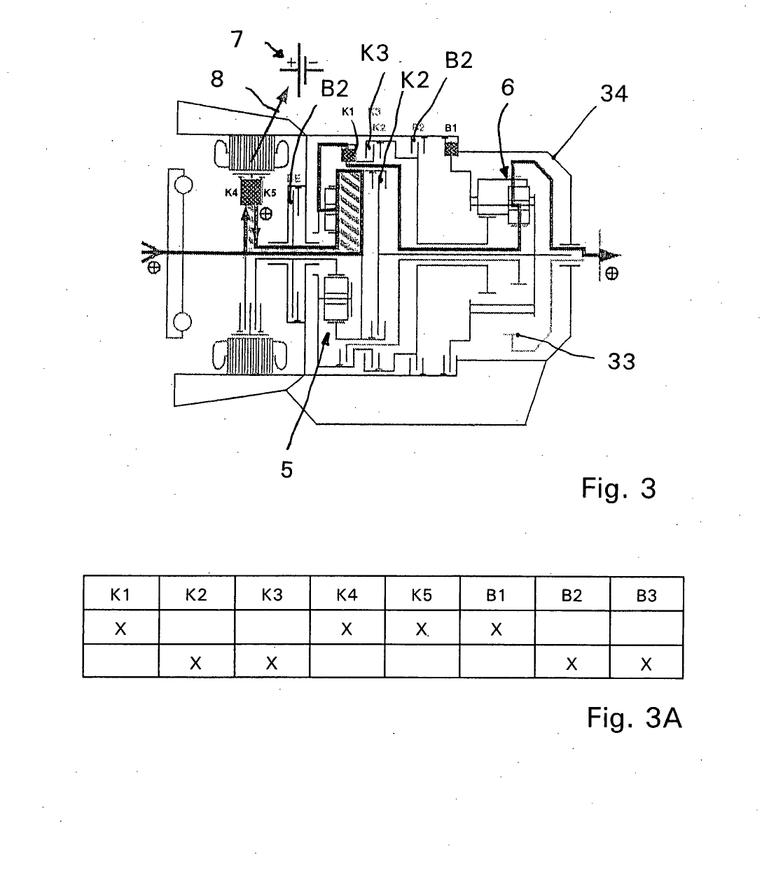

FIG. 3 is the transmission according to FIG. 1 in a 2^{nd} gear;

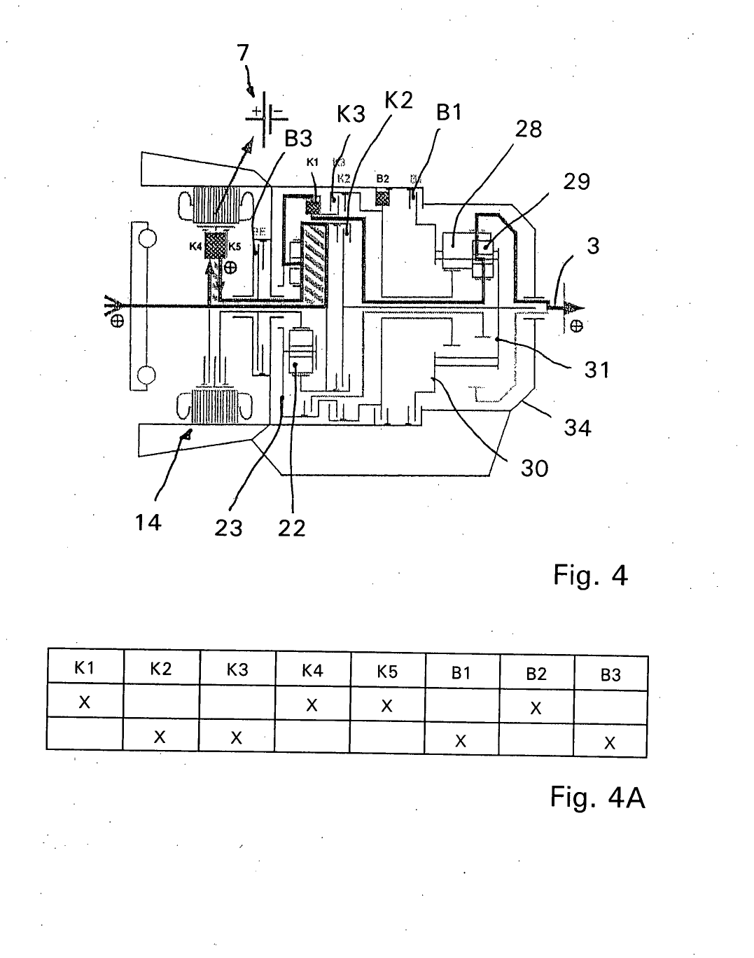

FIG. 4 is the transmission according to FIG. 1 in a 3^{rd} gear;

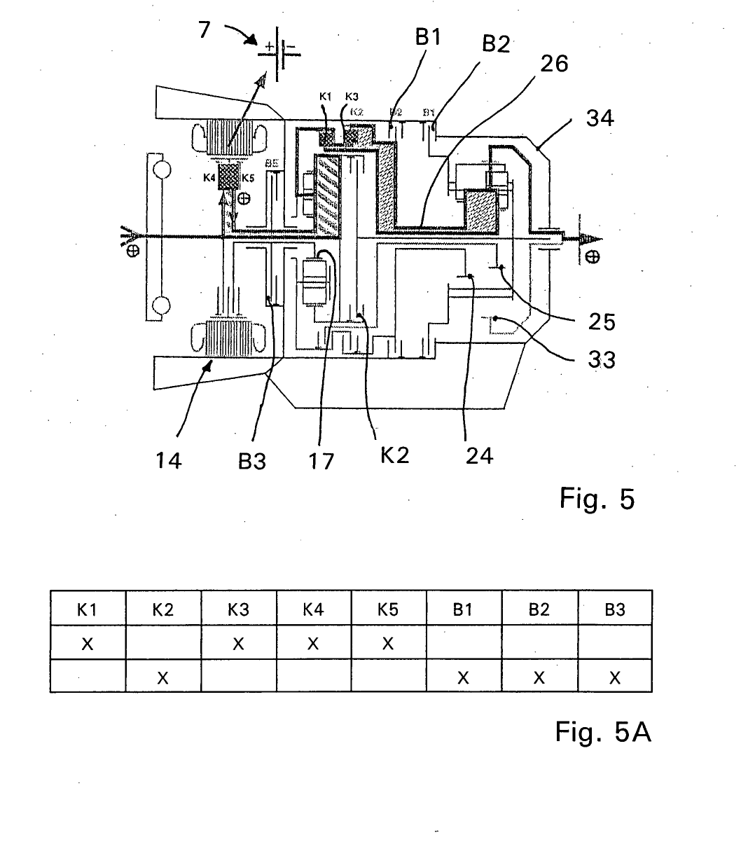

FIG. 5 is the transmission according to FIG. 1 in a 4^{th} gear;

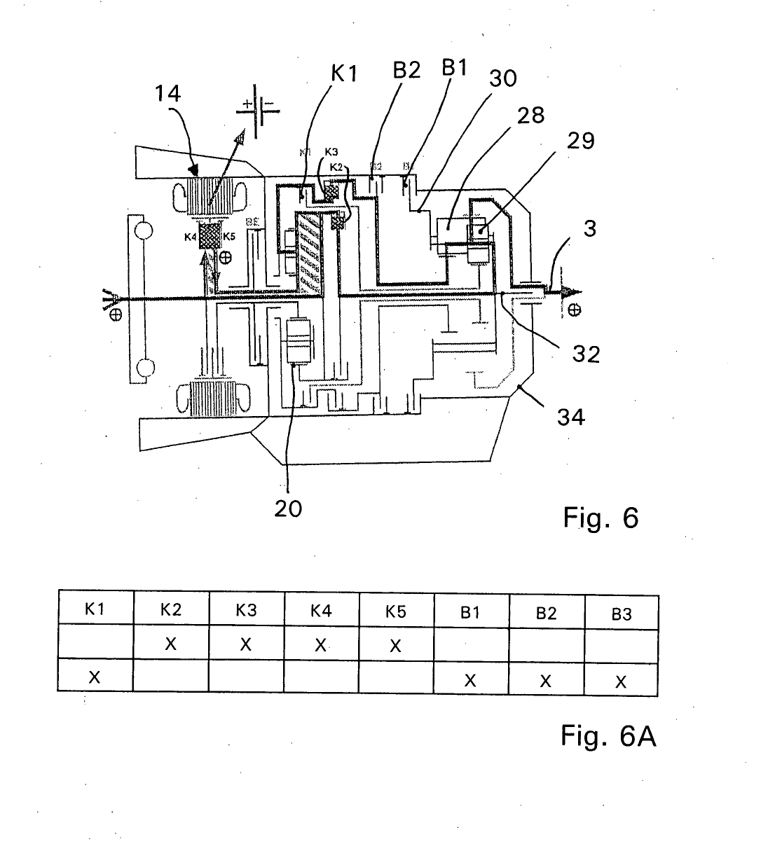

FIG. 6 is the transmission according to FIG. 1 in an intermediate stage; and

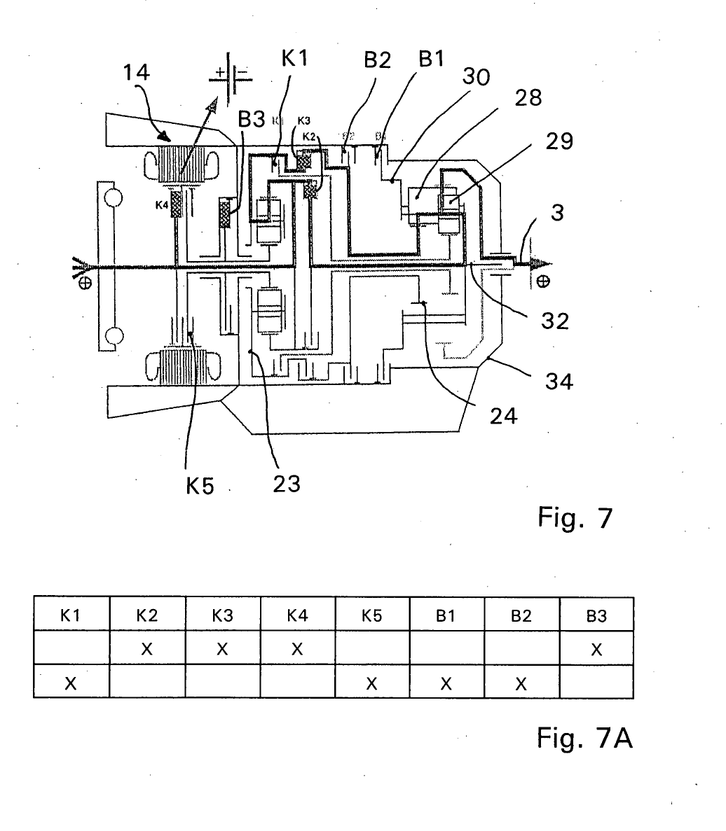

FIG. 7 is the transmission according to FIG. 1 in a 5^{th} gear.

In a table, under the respective figures, a cross indicates which of the shifting elements (detailed below), i.e. clutches and brakes, is engaged (in the middle row), while the bottom row indicates which of these elements is disengaged. An active flow of torque is also shown in the figures by means of a bolder line.

An automatic motor vehicle transmission 1 is part of a parallel hybrid drive train of a motor vehicle, which is not shown in more detail. This transmission 1 comprises an input shaft 2, which on the input side, for example, is connected via a torsion damper to an internal combustion engine of the drive train, which is not shown in more detail.

On the output side of the transmission 1, there is an output shaft 3 which can be connected with the drive of at least one vehicle axle. A transmission 4 is arranged between the two cited shafts 2 and 3, and comprises a first gear stage (first planetary gear set 5), and a second gear stage (second planetary gear set 6) with a plurality of clutches K1, K2, K3 and two brakes B1 and B2.

The first gear stage consists, for example, of a simple planetary gear set 5 located upstream from the second gear stage which is designed as a Ravigneaux set 6. This kind of arrangement enables, for example, an automatic transmission to have six forward gears and one reverse gear.

A sun gear 17 of the first planetary gear set 5 is connected, via a sun gear shaft 18, to a starting brake B3, so that a vehicle equipped with this transmission 1 can start without a hydrodynamic converter.

In addition, there is an electric machine 14, which is configured as a starter/generator. An electronic control system and an energy storage 7, which are not shown, are also dedicated to this electric machine 14.

The combination of the transmission 4 with the electric machine 14 makes it possible to electromotively start the vehicle equipped, with it, when the transmission selector lever is in a neutral position.

A fourth clutch K4 and a fifth clutch K5 are arranged between the electric machine 14, on one hand and the input shaft 2 and the sun gear shaft 18, on the other hand, which are both connected to a ring gear 20 of the first planetary gear set 5.

During a drive operation, not only can six forward gears with fixed transmission rations, but also five forward cruising ranges with continuously variable motor rotation speed can be selected by means of the variable-speed connection of the electric machine 14 with the sun gear shaft 18.

During drive operation, and in particular during braking of the motor vehicle, energy recovery is accomplished with the electric machine 14, when electrical energy is intermediately stored in the symbolically depicted energy store 7. A directional arrow 8 indicates whether the electric machine 14 is storing energy in or removing it from the energy store 7.

With a vehicle transmission of this type, both forward and backward can be produced electrically, for example in inner cities or in other zones where emission-free operation is desirable.

The ring gear 20 of the first planetary gear set 5 is permanently connected, via a ring gear shaft 21, to the input shaft 2. The planetary gears 22 are connected with a planet carrier 23, which can be connected, via the clutches K1, K2, and K3, with the second planetary gear set 6, or can be locked, via the brake B2, to a housing 34 of the transmission 1.

The second, double planetary gear set 6 consists essentially of a first sun gear 24 and a second sun gear 25, which can be respectively connected by means of a first sun gear shaft 26 and a second sun gear shaft 27 with the first planetary gear set 5, or can be locked by means of the brake B1 with the housing 34.

A set of first planetary gears 28 is disposed on a first planet carrier 30, which planet carrier 30, by means of the brake B1, can be locked with the housing 34. Both the first planetary gears 28 and the second planetary gears 29 can be connected by means of a second planet carrier 31 and an intermediate shaft 32 with the first planetary gear set 5. A ring gear 33 of the second planetary gear set 6 is directly connected with the output shaft 3 of the vehicle transmission 1.

According to FIG. 1, the internal combustion engine is not running; the vehicle is purely electromotively operated in this state. The clutches K1, K2 and the brake B1 are engaged, while the clutches K3 and K4 are disengaged.

The ring gear 20 of the first planetary gear set 5 is engaged by means of the engaging clutch K2 and the brake B1, which is also engaged, for reasons of the necessary torque transfer. The clutch K5 is also engaged. In this state, drawing electrical energy from the energy storage 7, the drive torque can be transmitted to the output shaft, via the engaged clutch K5, the sun gear shaft 18, the planet carrier 23, and the clutch K1, via the second sun gear shaft 27, which is assigned to the second planetary gear set 6, or via the locked planet carrier 30, which is locked by the brake B1, its planetary gears 29, and the assigned ring gear 33.

Inventively, according to FIG. 2, the internal combustion engine is started by disengaging the clutch K2 and engaging the clutch K4. Then both of the clutches K4 and K5 that are assigned to the electric machine 14 are engaged. The torque path, with reference to the starting point of the clutch K5, is identical to the configuration shown in FIG. 1, however, via the now disengaged clutch K2, part of the torque is transmitted to the disengaged ring gear 20 of the input shaft 2, as is the torque that is transmitted from the electric machine 14 to the input shaft 2 by way of the now engaged clutch K5.

The transmission ratio now amounts to i=2.74 and is therefore very similar to that of the 2^{nd} gear of the known basic gear unit 6HP26 where i=2.34.

As the input planetary gear set 5 initially remains locked using the clutches K4 and K5, the additional transmission ratios are only marginally different from those of the basic gear unit. Further, with the combination of the first and second planetary gear sets 5 and 6, two additional forward and one additional reverse gear can be engaged.

The status of the internal combustion engine after starting is shown in FIG. 3. In the table designated as to FIG. 3, nothing has changed when compared to FIG. 2. The internal combustion engine now initiates driving the vehicle in the 2^{nd} gear; no further clutch has to be engaged. The electric machine 14 can now be driven as a generator to supply electrical energy to the energy storage 7 (Arrow 8).

In order to shift into 3^{rd} gear, the brake B2 will now be engaged and B1 disengaged, as seen in FIG. 4. This releases the planet carrier 30 of the second planetary gear set 6, and the transmission ratio drops to i=1.54, when compared with 1.521 of the basic gear unit 6HP26.

When the 3^{rd} gear has been passed through, as seen in FIG. 5, the 4^{th} gear is engaged by again disengaging the brake B2 and engaging the clutch K3. The transmission ratio is then direct, i.e. i=1.0; the similar basic gear unit has i=1.143 in the 4^{th} gear.

For the next higher gear, being the 5^{th} gear, a total of four of the shifting elements would have to be simultaneously actuated for a direct shift. In order to avoid this and to implement a change of gear without loss of comfort, an intermediate gear-shifting stage, shown in FIG. 6, is realized, in which i=1.0 also applies. In order to do this, the clutch K1 is disengaged and the clutch K2 is engaged, by which the flow of torque is additionally transmitted from the ring gear 20, via the intermediate shaft 32 that is coupled with it by means of the clutch K2 to the planet carrier 31 of the planetary gear set 6.

Only then is the 5^{th} gear with i=0.867 shifted into by disengaging the clutch K5 and engaging the starting brake B3, which corresponds to the transmission ratio of the basic gear unit 6HP26 (FIG. 7).

Shifting into additional higher gears can then be accomplished as in the known basic gear unit and are therefore not explained in more detail here.

By means of the inventive use of two clutches K4 and K5, the electric machine 14 is directly connected via the clutch K4 with the input shaft 2 for starting the internal combustion engine. The input shaft 2, in turn, has a direct drive connection with the crankshaft of the internal combustion engine. This provides the additional advantage that initiating drive can be carried out comfortably and without perceptible interruption in driving power, in addition to the known advantages of the previously described motor vehicle transmission 1 with a manual transmission 4 and an electric machine 14, when desired, it is possible for a driver to freely increase the drive torque during acceleration.

What is more, by means of such interconnection, there is a permanent electrical supply available to the vehicle electric system during generator operation of the electric machine 14.

### REFERENCE SYMBOLS

1 Motor vehicle transmission
2 Input shaft
3 Output shaft
4 Manual transmission
5 First planetary gear set
6 Second planetary gear set
7 Energy store
8 Arrow direction
14 Electric machine
17 Sun gear
18 Sun gear shaft
20 Ring gear
21 Ring gear shaft
22 Planetary gear
23 Planet carrier
24 First sun gear
25 Second sun gear
26 First sun gear shaft
27 Second sun gear shaft
28 First planetary gears
29 Second planetary gears
30 First planet carrier
31 Second planet carrier
32 Intermediate shaft
33 Ring gear
34 Housing
K1 First clutch
K2 Second clutch
K3 Third clutch
K4 Fourth clutch
K5 Fifth clutch
B1 First brake
B2 Second brake
B3 Starting brake

1-11. (canceled)

12. A method of starting an internal combustion engine in a motor vehicle having a parallel hybrid drive train and an automatic transmission (4) featuring an input shaft (2) connectable to the internal combustion engine, an output shaft (3) connectable to at least one driving axle, first and second planetary gear sets (5, 6), a plurality of clutches, a plurality of brakes and an electric machine (14), the electric machine (14) facilitating at least one of starting the internal combustion engine, generating electrical power, continuously adjusting the transmission and electrically driving the vehicle, the method comprising the steps of:
engaging at least one of a third, a fourth and a fifth clutch (K1, K2, K3), at least one of a first, a second and a third brake (B1, B2, B3) and one of a first and a second clutch (K4, K5) to couple the electric machine (14) with one of a first shaft and a second shaft of the first planetary gear set to obtain purely electrically drive of the vehicle, and
engaging another of the first and the second clutch (K4, K5) to couple the electric machine (14) with the internal combustion engine, via the input shaft (2), to start the internal combustion engine.

13. The method according to claim 12, further comprising the step of connecting the electric machine (14), via the first clutch (K4), with a ring gear (20) of the first planetary gear set (5), and the ring gear (20) of the first planetary gear set (5), when the internal combustion engine is started, is directly coupled with the input shaft (2).

14. The method according to claim 12, further comprising the step of coupling the electric machine (14), via the other of the first and the second clutches (K4, K5), with a sun gear (17) of the first planetary gear set (5).

15. The method according to claim 12, further comprising the step of constructing the first and the second clutches (K4, K5) as independently controlled disc clutches.

16. The method according to claim 12, further comprising the step constructing the first and the second clutches (K4, K5) as independently controlled form-locking clutches.

17. The method according to claim 12, further comprising the step of, when the internal combustion engine is off, engaging at least one of the third, the fourth and the fifth clutches (K1, K2, K3) and at least one of the first, the second and the third brakes (B1, B2, B3) to couple a planet carrier of the first planetary gear set to a housing of the transmission.

18. The method according to claim 17, further comprising the step of, after starting the internal combustion engine, maintaining the planet carrier of the first planetary gear coupled to the housing of the transmission.

19. The method according to claim 18, further comprising the step of disengaging the at least one of the third, the fourth and the fifth clutches (K1, K2, K3) and at least one of the first, the second and the third brakes (B1, B2, B3) coupling the planet carrier of the first planetary gear to the housing in order to shift into a third gear.

20. The method according to claim 19, further comprising the step of actuating an intermediate shifting stage without a transmission ratio change for shifting into a gear higher than the third gear.

21. The method according to claim 20, further comprising the step of coupling a ring gear of the first planetary gear stage to a planet carrier of the second planetary gear set by engagement of at least one additional clutch of the first, the second, the third, the fourth and the fifth clutches (K4, K5, K1, K2, K3) to actuate the intermediate shifting stage.

22. The method according to claim 12, further comprising the step of producing transmission ratios, via the first and the second planetary gear sets (5, 6), equal to at least of 2.74, 1.54, 1.0 and 0.867.
